(19) United States
(12) Patent Application Publication
(10) Pub. No.: US 2014/0345473 A1
(43) Pub. Date: Nov. 27, 2014

(54) Self fill disposable coffee pod

(71) Applicant: Kenneth Buck Albritton, Ashland, VA (US)

(72) Inventor: Kenneth Buck Albritton, Ashland, VA (US)

(21) Appl. No.: 14/120,458

(22) Filed: May 20, 2014

Related U.S. Application Data
(60) Provisional application No. 61/855,727, filed on May 22, 2013.

(51) Int. Cl. A47J 31/06

(52) U.S. Cl. CPC A47J 31/06
USPC 99/323

(57) ABSTRACT

The Self Fill Disposable Coffee Pod provides a solution to neatly and easily prepare customized single serve coffee pods for use in single serve coffee makers. Freshly ground and customized coffee grounds mixtures can be used in the Self Fill Disposable Coffee Pod without the need to clean after use as it is designed to have an option to be disposable and or compostable. The invention can be manufactured without plastic or non biodegradable components and can be completely biodegradable and yet strong enough to be used as a scoop to fill its cavity with grounds of user's choice utilizing the quantity desired.

### CROSS-REFERENCE TO RELATED APPLICATIONS

This application claims priority to U.S. Provisional Application Ser. No. 61/855,727, filed May 22, 2013.

### FIELD OF THE INVENTION

This invention relates to the field of single serve coffee pods. More specifically, the invention comprises a potentially disposable coffee pod, which allows the user to use it as a scoop and fill the pod themselves with the coffee or tea grounds of their choice and if preferred, freshly ground coffee or tea. It replaces the pre packaged coffee pods lowering the cost of a single serve pod as well as providing more choices and provides an option to use freshly ground coffee.

### BACKGROUND

There are limited pre packaged coffee options available in disposable coffee pods, which are expensive relative to bulk purchased coffee. And there are some reusable pod options that allow coffee drinkers to load their own bulk purchased coffee without the convenience and ease provided by the pre packaged coffee options. The reusable options require cleaning after each use and create difficulty to maintaining them. Many do not have the lids attached nor can many have the support necessary to use them to scoop the grounds into their filter cavity nor do they have enough space on the lid to grip the pod so it may be used as a scoop.

### BRIEF SUMMARY OF THE INVENTION

The present invention relates to a disposable coffee pod that the user fills with their preferred grounds and is not limited by what is available in pre packaged forms that are available on the market. The Self Fill Disposable Coffee Pod provides a means to brew fresh ground coffee in the single serving coffee makers and to custom mix coffee or tea blends. Additionally, any percentage of decaf coffee may be included in the user's customized mixture. The invention's design allows it to be made wholly of cardboard or other fibrous biodegradable material and remain strong enough in structure to be used as a scoop in filling it's cavity and withstand the pressure and stress applied by a single serve coffee maker. Since the filter cavity can fold or be pressed against the bottom of the lid, the invention can be packaged and stored using less space than many of the hard plastic pods available.

### BRIEF DESCRIPTION OF THE DRAWINGS

A better understanding of the present invention may be obtained by reference to the accompanying drawings, when considered in conjunction with the subsequent, detailed description, in which:

FIG. 1 is a perspective view, showing the freely moving lid in a partially opened positioned.

FIG. 2 is a perspective view, showing the lid closed and attached to the coffee filter pod support rim.

FIG. 3 is a top view, showing the portion of the lid sealed to its rim with the live hinge portion of the lid open. The view shows the support wall option built into the circular rim providing an area for the coffee filter material to be attached with adhesive that can be biodegradable.

FIG. 4 is a view from the bottom showing the coffee filter material and the bottom view of the support rim that rests on the coffee maker's ridge when it is inserted into the coffee maker.

FIG. 5 is a perspective view from the top, showing the pod from a different angle with the opened portion of the pod more exposed. Also shown in this drawing is the optional tape when removed exposes an adhesive that seals the free moving lid once it is pressed down to its rim.

FIG. 6 is a perspective view showing another of many optional lid shapes.

### REFERENCE NUMERALS IN THE DRAWINGS

For purposes of clarity and brevity, like elements and components will bear the same designations and numbering throughout the drawings.

| | |
|---|---|
| 10 water entry | 12 hinged lid |
| 14 rim support wall | 16 rim top surface |
| 18 secured lid portion | 20 filter material |
| 22 reinforced filter bottom | 24 optional lid |
| 26 optional secured lid | 28 optional secured lid |
| 30 tape covering | 32 adhesive material |

### DETAILED DESCRIPTION

The following detailed description is merely exemplary in nature and is not intended to limit the described embodiments or the application and uses of the described embodiments.

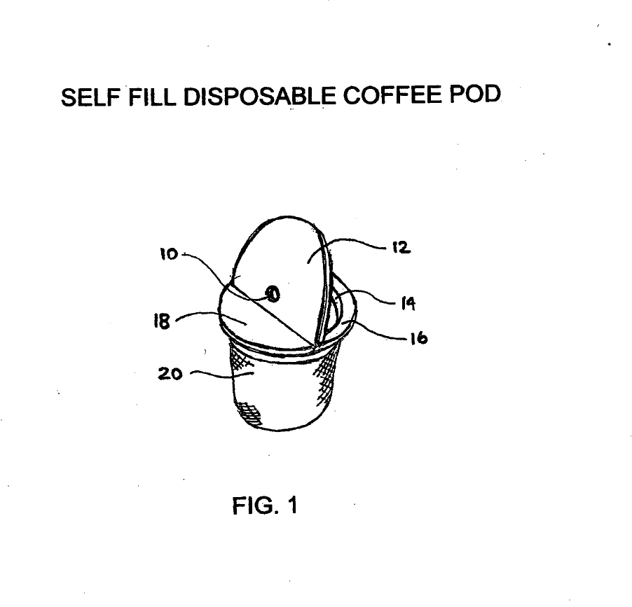

FIG. 1 shows a perspective view of the present invention with the hinge lid 12, that can be a live hinge, raised to an opened position allowing access to the interior of the pod that can be filled with coffee or tea grounds for brewing. The hinge lid 12, can be a separate shaped cardboard, biodegradable or other material with a sheet of paper or other material adhered to both the hinged lid 12, and the secured lid portion 18, with the sheet of paper to be used as the connector and hinge to allow the free moving portion of the lid to open and close. The secured lid portion 18, is permanently secured to the rim top surface 16, providing additional strength to the structure and convenience to the user. The permanently secured lid portion 18, of the top lid may cover as much as seventy five percent of the top lid area or as small of an area as required to still provide the desired strength to the invention. The hinged lid 12, can be the size and shape able to fit in the space of the top lid which the permanently secured lid portion 18, does not cover of the top portion of the invention including the area of the rim top surface 16. The water entry point 10, provides an area where a coffee maker can penetrate the lid and dispense heated water for brewing of the coffee grounds contained in the pod. The water entry 10, can be partially carved into the cardboard, biodegradable material or other material of the hinged lid 12, to allow penetration of the coffee maker so that water can be dispensed into the pod. The water entry 10, could also be partially carved into the secured lid portion 18, with the secured lid portion 18, enlarged to allow the water entry 10, to be centered in the pod top surface rather than in the hinged lid 12, as shown in FIG. 1. The water entry 10, may be fully carved or drilled into either the hinged lid 12, or the secured lid portion 18, depending on where the centering of the hole is located for the water entry 10, and may then be covered by a sheet of paper, cardboard, biodegradable material or other material and allow the coffee maker's penetration to deliver the heated water for brewing. The rim support wall 14, provides support for the rim top surface 16, and provides a connection point for the filter material 20. The rim support wall 14, may be made from the same sheet of card board, biodegradable material or other material as the rim support wall 14, by bending down the material while shaping it to the round rim top surface 16. Making incisions into the rim support wall 14, could assist in the desired shaping. The filter material 20, used to prevent the coffee grounds or other brewing material from entering the user's cup is attached to the inside or outside of the rim support 14 that may utilize an adhesive. The filter material 20, may be made of cotton, biodegradable material or other material and shaped into a cylinder shape and may be woven, glued or use of other means to reach its desired shape and secured to the rim support wall 14. A resin, wax, glue or other material that may be biodegradable may be applied to all or parts of the invention to provide additional strength.

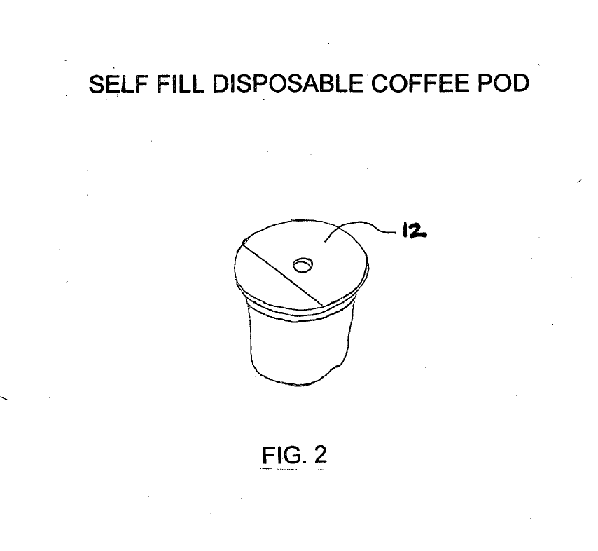

FIG. 2 shows a perspective view of the present invention with the hinged lid 12, closed. With the pod filled with coffee or other desired brewing substance the Coffee Self Fill Disposable Pod is ready for installation into the coffee maker.

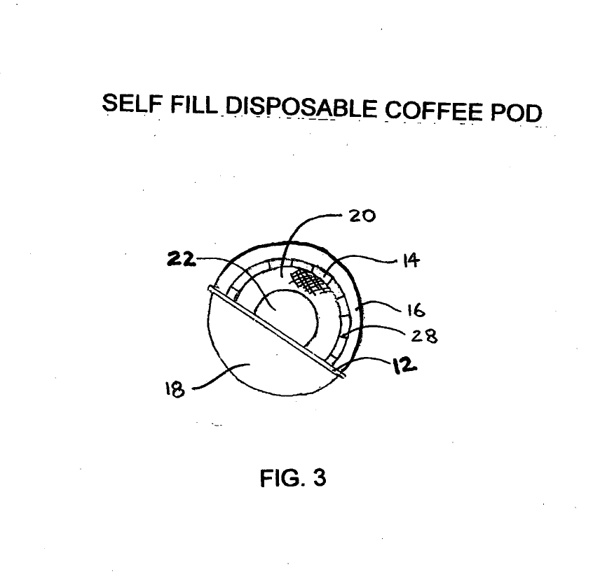

FIG. 3 shows a top view of the present invention with the hinged lid 12, opened to a 90 degree angle exposing the cavity of the pod. Shown in the drawing is the rim support wall 14, with optional dissected lid support sections 28, to allow for shaping of the rim support wall 14, to accommodate the round shape of the rim top surface 16. Also shown is the reinforced filter bottom 22, which provides added strength for filter material 20, that may be needed to handle the pressure of the water stream injected into the pod from the coffee maker. The reinforced filter bottom 22, can be made of cardboard, biodegradable material or other material and may cover a portion or the entire bottom of the filter material 20. The reinforced filter bottom 22, may be strengthened with a resin, wax, glue or other material. The reinforced filter bottom 22, can be different shapes that adequately diffuses the pressured water entering the cavity of the filter material 20, so that tearing or ripping of the filter material 20, doesn't result. The pressured water is diffused once it comes into contact with the reinforced filter bottom 22. The reinforced filter bottom 22, may or may not be required for the invention to function satisfactorily.

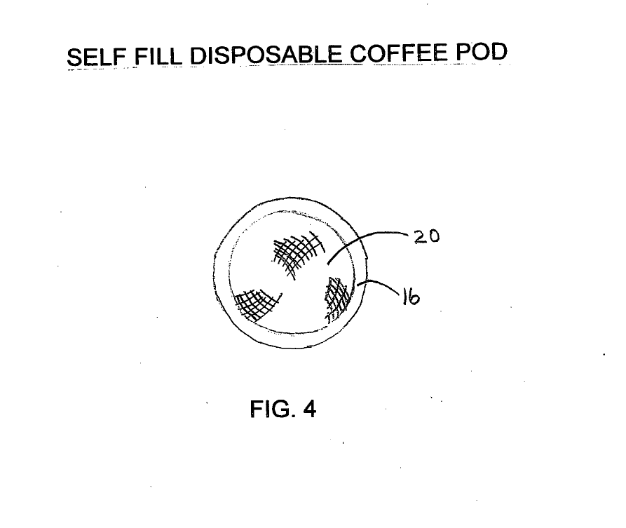

FIG. 4 shows a bottom view of the present invention with the filter material 20, shown and the bottom view of the rim top surface 16, shown.

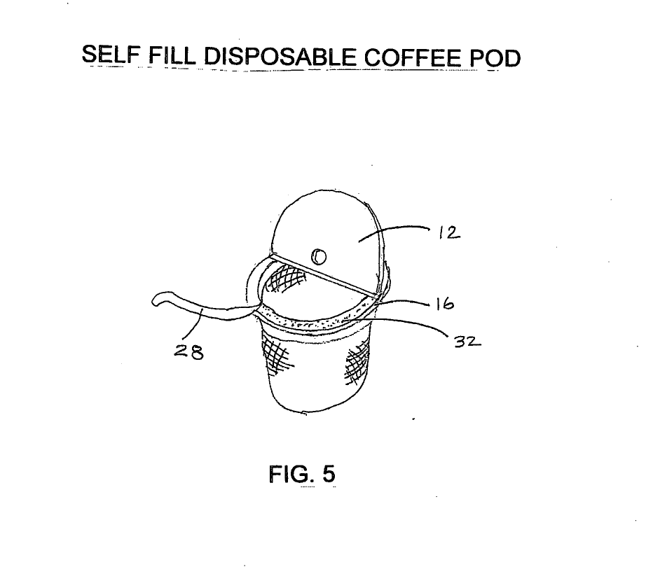

FIG. 5 shows a perspective view of the present invention with tape covering 30, partially unattached from the adhesive material 32, which allows the optional securing of the hinged lid 12, to the rim support wall 14. The tape covering 30, for the adhesive material 32, allows the user to fill the invention with coffee grounds without the grounds adhering to the adhesive material 32. Once the desired amount and mixture of brewing grounds are placed into the invention's cavity the tape may be removed and the freely moving hinged lid 12, can be pressed to the rim top surface 16, securing it for the brewing process.

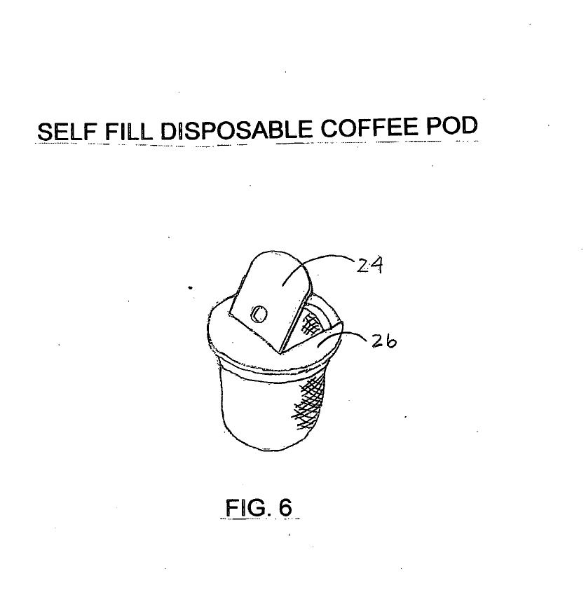

FIG. 6 shows a perspective view of the present invention with the optional shape of the optional lid 24, that provides a smaller opening for loading coffee grounds for brewing and provides additional strength to the structure due to the increased surface area that is secured on the rim top surface 16.

The Self Fill Disposable Coffee Pod can be filled with desired coffee, tea or other substances that may be brewed by the user allowing many more options than what is offered on the market with the pre filled coffee pods. The invention can be composed of cardboard, fiberous or biodegradable material that allows the invention to be compostable. Since the invention can be made to be disposable it could provide more convenience for the user than the reusable coffee pods on the market, that require cleaning and maintaining after use. The Self Fill Disposable Pod can be comprised completely or partially of a material suitable for composting. The design of its partially permanently affixed lid provides additional strength and can be used as a scoop to fill its cavity with coffee or tea grounds directly from a bulk container without the use of a separate spoon, scoop or other implement saving time. The permanently attached portion of its covering lid could be as little as 15% of the pod's opening or as much as 75% of pod's opening with the hinged free moving portion of the lid to be of size and shape to fit in the remaining uncovered pod opening and covering the support rim top surface. Buying in bulk can save significant money for the user. The portion of the lid secured to the rim for added strength also provides an area for the user to grip the invention when scooping coffee or tea grounds into its cavity. The attached free moving portion of its lid can be secured after filling the filtered cavity. A tape covering adhesive on the rim can be removed once the pod is filled with preferred coffee or tea grounds and the free moving portion of the lid may be secured to the rim prior to insertion into the coffee maker. The invention's optional reinforced filter bottom aids in its resistance to tearing when a pressured stream of water is applied by the coffee maker and may be applied to either side of the filter material. The rim may be manufactured from one piece of cardboard in the shape of a circle with the center removed and the inner portion of the ring of cardboard being pressed or bent downward resulting in increased strength for the rim and a connection point for the filter material. The inner portion of the rim may have slits cut into it to allow for desired shaping. This invention reduces time required for its use compared to reusable coffee pods as it is disposable and doesn't require cleaning, has a pre attached lid and adhesive applied rim for immediate lid attachment after filling the filter cavity. The pod filter can be reinforced at the bottom diffusing the water pressure applied by the coffee maker allowing the filter to require a less strong fibrous filter. A tape covering the adhesive applied to the rim portion can be removed once the coffee or tea grounds are scooped into the invention. Once the lid is pressed down on the exposed adhesive, a secure seal is made. For additional containment of the water in the pod, an additional seal may be placed over or under the manufactured hole in the lid created as the water entry point.

It is an objective to have a Self Fill Disposable Coffee Pod that can effectively be filled with the user's coffee or brewing choice and be utilized in a single serve coffee maker.

It is another object to have a Self Fill Disposable Coffee Pod that can be disposed so cleaning or maintaining after use is not necessary.

It is another object to have a Self Fill Disposable Coffee Pod, which is reinforced by design so that it can be utilized as a scoop to load coffee grounds in its filter cavity without breaking or bending.

It is another object to save time by being able to fill the pod with coffee or tea grounds quickly without spillage or waste.

It is another object to save money by being less expensive to manufacture than many of the pre filled plastic pods.

It is another object for the invention not to require plastic elements so it can be wholly biodegradable or compostable.

It is another object to have the Self Fill Disposable Coffee Pod filter reinforced with fibrous or other material at the bottom of the filter portion to prevent pressurized water applied by a single serve coffee maker from forcing a hole in the filter.

It is another object to have the Self Fill Disposable Coffee Pod have as an option adhesive on its rim where the lid connects when closed to secure the lid which may aid in the brewing process of the single serve coffee maker.

It is another object for the Self Fill Disposable Coffee Pod to have a top lid that is attached to the rim of the pod saving time for the user.

It is another object for the Self Fill Disposable Coffee Pod to have a portion of the top lid permanently secured to the rim providing added strength to the rim permitting the pod to be filled by scooping it into the coffee or tea grounds. It also serves as a gripping area for the user's fingers or thumb.

That which is claimed:

1. A single use biodegradable brewing pod comprising:
a cylindrical body comprising a biodegradable filter media forming a wall and having a top end and a bottom end;
a circular bottom affixed to the bottom end of the cylindrical body and comprising a biodegradable filter media;
a top rim affixed to the top end of the cylindrical body and comprising a biodegradable material; and
a lid comprising (i) a fixed portion affixed to the top rim and (ii) a hinged portion hingedly affixed to the fixed portion, the hinged portion selectively movable between (a) an open position in which infusible material may be placed into an interior chamber of the brewing pod through an opening defined by at least part of the rim and at least part of the fixed portion and (b) a closed position in which at least a portion of an outer perimeter of the hinged portion contacts the top rim such that the opening defined by the at least part of the rim and the at least part of the fixed portion is closed off when the hinged portion is in the closed position.

2. The brewing pod of claim 1, wherein the wall of the cylindrical body is angled inward from the top end to the bottom end such that a diameter of the top end is greater than a diameter of the bottom end.

3. The brewing pod of claim 1, wherein the biodegradable filter media comprises biodegradable material.

4. The brewing pod of claim 1, further comprising:
a reinforcing member affixed to an inside or outside surface of the circular bottom, the reinforcing member comprising a biodegradable material that in conjunction with the material of the circular bottom, is stronger and/or thicker than the biodegradable filter media of the circular bottom.

5. The brewing pod of claim 4, wherein the reinforcing member does not comprise filter media.

6. The brewing pod of claim 4, wherein the reinforcing member comprises paperboard or cardboard.

7. The brewing pod of claim 4, wherein the reinforcing member has a diameter that is selected such that the reinforcing member fits snugly within the wall of the cylindrical body at the bottom end.

8. The brewing pod of claim 4, wherein the reinforcing member has a diameter that is smaller than a diameter of the circular bottom such that a perimeter portion of the circular bottom is not covered by the reinforcing member.

9. The brewing pod of claim 1, wherein the top rim does not comprise filter media.

10. The brewing pod of claim 1, wherein the top rim comprises paperboard or cardboard.

11. The brewing pod of claim 1, wherein the top rim comprises a top surface and a skirt projecting downward therefrom; and wherein the top end of the cylindrical body is affixed to the skirt.

12. The brewing pod of claim 11, wherein a plurality of generally vertical gaps are defined in the skirt.

13. The brewing pod of claim 12, wherein the plurality of generally vertical gaps are spaced about a circumference of the skirt.

14. The brewing pod of claim 1, further comprising a selectively activated adhesive portion that enables the hinged portion of the lid to be adhered to the top rim in the closed position.

15. The brewing pod of claim 15, wherein the selectively activated adhesive portion comprises an adhesive covered by a removable protective strip, the adhesive being on either the top rim or the hinged portion.

16. The brewing pod of claim 1, wherein the fixed portion and the hinged portion of the lid are unitary; and wherein a live hinge is formed in the lid where the fixed portion and the hinged portion meet.

17. The brewing pod of claim 1, wherein the fixed portion and the hinged portion of the lid are not unitary and are hingedly affixed by a flexible biodegradable material that is affixed to at least a portion of the fixed portion and at least a portion of the hinged portion.

18. The brewing pod of claim 17, wherein the flexible biodegradable material comprises paper.

19. The brewing pod of claim 1, wherein a through-hole is defined in the fixed portion or the hinged portion of the lid; and wherein the through-hole is covered by a biodegradable material affixed to the fixed portion or the hinged portion of the lid surrounding the through-hole, the biodegradable material covering the through-hole being thinner and/or weaker than the biodegradable material of the lid.

20. The brewing pod of claim 19, wherein the biodegradable material covering the through-hole comprises paper or filter media.

21. The brewing pod of claim 1, wherein a partial thickness hole is defined in the fixed portion or the hinged portion of the lid.

22. The brewing pod of claim 1, wherein the lid does not comprise filter media.

23. The brewing pod of claim 1, wherein the lid comprises paperboard or cardboard.
